(19) United States
(12) Patent Application Publication
(10) Pub. No.: US 2023/0289833 A1
(43) Pub. Date: Sep. 14, 2023

(54) STOCHASTIC ECONOMIC EVALUATION TOOL

(71) Applicant: Partners for Production Agriculture, LLC, Ames, IA (US)

(72) Inventors: Joseph Kerns, Boone, IA (US); Caitlyn Bruns, Saratoga Springs, UT (US); Benjamin Freking, Ames, IA (US); Michael Porth, Ames, IA (US)

(21) Appl. No.: 18/180,519

(22) Filed: Mar. 8, 2023

Related U.S. Application Data
(60) Provisional application No. 63/317,667, filed on Mar. 8, 2022.

(51) Int. Cl. G06Q 30/0202; G06Q 30/0201; G06Q 30/0283; G06Q 50/02

(52) U.S. Cl. CPC G06Q 30/0202; G06Q 30/0206; G06Q 30/0283; G06Q 50/02

(57) ABSTRACT

A method of predicting profitability of a livestock operation. Information about a plurality of animals in the livestock operation, live futures prices, and historical price discoveries are provided. A stochastic simulation is implemented to model the production performance of the animals combined with the live futures prices and the historical price discoveries to calculate and display a distribution of expected profitability for the livestock operation.

### CROSS REFERENCE TO RELATED PATENT APPLICATION(S)

This present utility patent application claims priority to U.S. Provisional Patent Application No. 63/317,667 entitled “Stochastic Economic Evaluation Tool” filed on Mar. 8, 2022, which is fully incorporated by reference herein.

### FIELD OF THE DISCLOSURE

This disclosure relates generally to stochastic modeling, and in particular to using a stochastic simulation to predict the expected profitability of a livestock operation.

### BACKGROUND OF THE DISCLOSURE

Livestock sale prices vary continuously during market open times, and the costs of inputs used in livestock production also vary continuously. Livestock producers and other livestock industry stakeholders need to evaluate the expected profitability of their operation under various market scenarios in order to make profitable decisions for the operation. There currently are no tools available that combine production information with financial values to forecast the distribution of expected profitability of a livestock operation. Another need for the industry is a tool that provides users with the capability to evaluate the impact of changes in production levels and/or market conditions on profitability. An additional need for the industry is a tool that can be used to evaluate the impact of an intervention (e.g. health product or nutritional intervention) on profitability of an operation and the return on investment (ROI) of the intervention.

Currently available products for making financial decisions do not incorporate production information with historical price discovery or current market prices. Additionally, current products do not provide a distribution of expected profitability or a confidence interval around the predicted profitability. Current financial planning software uses linear models and average values that do not fully account for livestock production and input market variability.

For the reasons stated above, and for other reasons which will become apparent to those skilled in the art upon reading and understanding the specification, there is a need in the art for an economic evaluation tool that allows users to predict the profitability of a livestock operation. Thus it is a primary object of the disclosure to provide a model incorporating stochastic simulation to predict the expected profitability of a livestock operation.

These and other objects, features, or advantages of the present disclosure will become apparent from the specification and claims.

### BRIEF SUMMARY OF THE DISCLOSURE

The disclosure relates to an economic evaluation method. In one arrangement, a user of software implementing the economic evaluation method enters baseline production values for the operation of interest, the percentage of ingredients in the feed ration, animals committed to the futures, and also input the expected production change(s) with an intervention. The user also enters their price discovery with the contract blend for each packer. Historical live animal prices are calculated based on the supplied information. A stochastic simulation is executed to determine the performance, cost, and revenue for a set of 1,000 production groups with and without the intervention changes. The profitability for each group is calculated and the distribution for the 1,000 groups is displayed. The results may then be exported, saved, and analyzed by the user.

### BRIEF DESCRIPTION OF THE DRAWINGS

FIG. 1 depicts an economic evaluation method according to one embodiment.

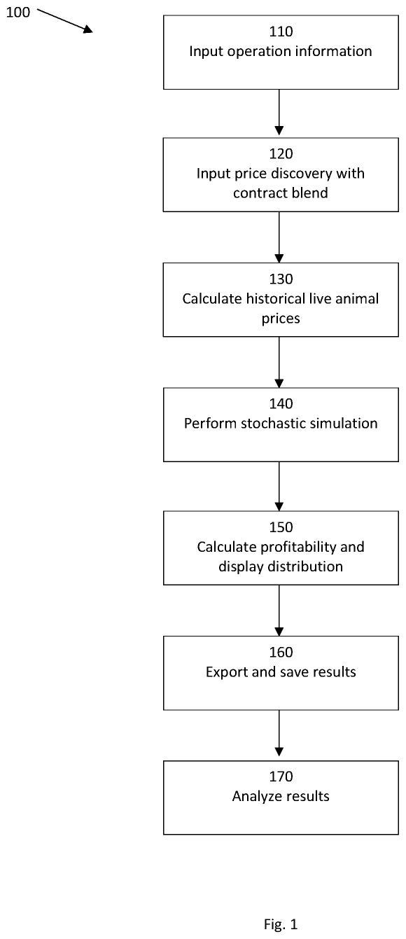

### DETAILED DESCRIPTION

In the following detailed description of the embodiments, reference is made to the accompanying drawings which form a part hereof, and in which is shown by way of illustration specific preferred embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the present disclosures. The following detailed description is, therefore, not to be taken in a limiting sense, and the scope of the present disclosure is defined only by the appended claims, along with the full scope of equivalents to which such claims are entitled.

As used herein, the terminology such as vertical, horizontal, top, bottom, front, back, end and sides are referenced according to the views presented. It should be understood, however, that the terms are used only for purposes of description, and are not intended to be used as limitations. Accordingly, orientation of an object or a combination of objects may change without departing from the scope of the disclosure.

An economic evaluation method 100 is disclosed. Economic evaluation method 100 may be referred to as economic evaluation tool 100 or stochastic evaluation tool 100 without departing from the scope of the disclosure. Economic evaluation tool 100 uses the results from a stochastic simulation to plot or display in another manner the distribution of expected profitability for a group of animals produced by a livestock operation. Producers and other stakeholders can use the results when making decisions regarding the operation. Additionally, the user can evaluate different scenarios (i.e. changes in production performance or changes in the financial market) to understand the impact on profitability with historical and/or forward pricing mechanisms. The impact of a specific intervention can be evaluated compared to base line production performance. The economic evaluation method 100 utilizes stochastic simulation to predict the expected profitability for a production group from a livestock operation. The production performance, feed cost, non-feed cost, and revenue are predicted for each animal in the production group and the profitability is calculated after removing a percentage of the animals due to mortality. Seasonal changes in production are included in the calculations. The profitability estimated with the operation's baseline production values can be compared to the profitability estimated with production values expected with an intervention. This allows a cost:benefit analysis and the resulting ROI are performed to evaluate whether an intervention should be implemented in the operation.

The economic evaluation method 100 uses stochastic simulation to estimate the production performance, total costs, and revenue for a group of animals marketed together from a livestock operation. The simulation is run for a week's worth of production from the number of sow units inputted. The economic evaluation method 100 begins at step 110 wherein a user supplies information about the operation including baseline production values for the operation of interest, the percentage of ingredients in the feed ration, animals committed to the futures, and the expected production change with an intervention. The seasonality effects will be based on the date the pigs will be weaned entered at step 110. Seasonality effects can be estimated on a monthly basis; however, using other time periods to estimate seasonality effects may be implemented without departing from the scope of this disclosure. At step 110 the user will supply the expected change in key production indicators (i.e. reducing mortality by 0.5% or increasing average daily gain by 0.02 lb per day) and the cost of the intervention. Examples of possible interventions include administering a pharmaceutical product that results in improved feed conversion, feeding a more energy rich diet that results in higher average daily gain, or implementing a genetics change that might impact all production variables; however other interventions may be implemented without departing from the scope of the disclosure. The operation may be a single farm or an entire production system comprising multiple farms. The user can choose the percent of ingredients in the feed ration and market animals that are committed to the futures prices. The cost or revenue for the percentage not purchased or sold on the futures is based on historical values. Historical values for the ingredient costs are based on the feed cost inputted by the user. The starting number of animals in the production group is calculated based on user-supplied values. Once the starting number of animals is determined, a model is used to calculate a starting physical weight for each animal based on the average starting weight and variance supplied by the user.

At step 120 the user enters their price discovery with the contract blend for each packer. Step 120 uses historical values reported for the price per hundred pounds of carcass. For example, there is a Western Corn Belt price, a cut-out price, and a CME index price. A producer and packer contract describes how the producer will be paid relative to one or a combination of those prices. For example, a producer may receive 93% of the cut-out price for 50% of the pigs sold to the packer and +$3.00 of the Western Corn Belt price for the other 50%. Based on the historical values, the economic evaluation method 100 can compare the price producers received from the packer relative to the CME index price. The difference is called the basis. Using the historical basis, the economic evaluation method 100 can forward project the expected price based on the current futures.

At step 130 historical live animal prices are calculated based on the information supplied in step 120. Historical values for the live animal prices are based on the historical values for the contract blends submitted by the user at step 110.

At step 140 a stochastic simulation is executed to determine the performance, cost, and revenue for a set of production groups with and without the intervention changes from Step 110. In one embodiment, a set of 1,000 production groups is simulated, but another number of production groups may be simulated without departing from the scope of the disclosure. After the starting weights are established, mixed linear regression models are used to determine the ending performance of each animal in the production group. Similarly, mixed linear regression models are used to assign a cost and revenue for each pig in the group. The expected mortality in each stage of production is estimated and animals are removed from the group based on a simulated distribution. The coefficients used in the regression models are obtained from multi-year datasets from producers representative of the industry. The feed costs and revenues are based on the live futures prices for ingredients and live market animals. The impact of interventions on profitability can be evaluated by inputting the expected production performance change based on the intervention. The cost and revenue based on the intervention performance accounting for the cost of the intervention is estimated and used to calculate profitability when the intervention is applied to the production group. This profitability is compared to the profitability calculated using baseline production values. A large number of production groups are simulated to determine the expected distribution of the profitability for a production group. For example, a total of 1,000 production groups may be simulated.

At step 150 the profitability for each group is calculated and the distribution for the large number of production groups is displayed in a visual format for the user to view. In one embodiment, these results are presented as a histogram of the profitability for the simulated production groups; however the results may be displayed in another format without departing from the scope of the disclosure. A confidence interval around the predicted profitability is calculated and displayed to the user. A standard deviation/distribution curve to show “risk” or probability is calculated and displayed to the user. In one embodiment, the standard deviation/distribution curve is displayed as the expected profitability for the bottom 10%, bottom 25%, median, top 25% and top 10% of the simulated production groups; however, the standard deviation/distribution curve may be displayed in another manner without departing from the scope of the disclosure.

At step 160 the results may be exported and saved by the user.

At step 170 the user can evaluate multiple scenarios by varying the production or financial parameters. The impact of production improvements on profitability can be determined. Additionally, profitability can be based on historical pricing, the futures prices, or a combination of historical and forward looking prices.

The method 100 has many benefits and advantages including, but not limited to improving the user's ability to make profitable decisions for a livestock operation. These and other benefits and advantages of the method 100 are apparent from the specification and claims.

### REFERENCE NUMERALS

100—economic evaluation method, also called an economic evaluation tool or stochastic economic evaluation tool
110—method step: input of operation information
120—method step: input of price discovery with the contract blend for each packer
130—method step: historical live animal prices are calculated
140—method step: stochastic simulation
150—method step: profitability for each group is calculated and the distribution for the groups is displayed
160—method step: results are exported and saved
170—method step: analysis of results

What is claimed:

1. A method of predicting a profitability level of a livestock operation comprising:
providing information about a plurality of animals in the livestock operation;
providing live futures prices;
providing historical price discoveries;
implementing a stochastic simulation to model a production performance of the animals combined with the live futures prices and the historical price discoveries to calculate a distribution of expected profitability of the livestock operation; and
displaying the distribution of expected profitability to a user.

2. The method of claim 1 wherein implementing a stochastic simulation further comprises modeling an economic impact of implementing an intervention in the livestock operation.

3. The method of claim 2 wherein modeling an economic impact of implementing an intervention in the livestock operation comprises evaluating an effect of the intervention on an expected cost and revenue associated with the animals.

4. A method of predicting an economic impact of implementing an intervention in a livestock operation comprising:
providing information about a plurality of animals in the livestock operation;
providing live futures prices;
providing historical price discoveries;
implementing a stochastic simulation to model an expected cost and an expected revenue based on a production performance of the animals combined with the live futures prices and the historical price discoveries; and
displaying a distribution of the expected cost and the expected revenue to a user.

5. A method of predicting a profitability level of a livestock operation comprising:
providing information about a plurality of animals in the livestock operation;
providing live futures prices;
providing historical price discoveries;
implementing a stochastic simulation to model a production performance of the animals accounting for seasonality effects combined with the live futures prices and the historical price discoveries to calculate a distribution of expected profitability of the livestock operation; and
displaying the distribution of expected profitability to a user.

6. The method of claim 5 wherein implementing a stochastic simulation further comprises modeling an economic impact of implementing an intervention in the livestock operation.

7. The method of claim 6 wherein modeling an economic impact of implementing an intervention in the livestock operation comprises evaluating an effect of the intervention on an expected cost and revenue associated with the animals, including the cost of the intervention.

8. A method of predicting an economic impact of implementing an intervention in a livestock operation comprising:
providing information about a plurality of animals in the livestock operation;
providing live futures prices;
providing historical price discoveries;
implementing a stochastic simulation to model an expected cost and an expected revenue based on a production performance of the animals combined with the live futures prices and the historical price discoveries; and
displaying a distribution of the expected cost and the expected revenue to a user, including the cost of the intervention.
